(19) United States
(12) Patent Application Publication
(10) Pub. No.: US 2011/0310447 A1
(43) Pub. Date: Dec. 22, 2011

(54) METHOD FOR GENERATING 3D VIDEO COMPUTER GENERATED HOLOGRAM USING LOOK-UP TABLE AND SPATIAL REDUNDANCY, AND APPARATUS THEREOF

(75) Inventors: Eun-Soo Kim, Seoul (KR); Seung-Cheol Kim, Seoul (KR)

(73) Assignees: Eun-Soo Kim, Seoul (KR); Kwangwoon University Research Institute for Industry Cooperation, Seoul (KR); Seung-Cheol Kim, Seoul (KR)

(21) Appl. No.: 12/817,636

(22) Filed: Jun. 17, 2010

(51) Int. Cl. G03H 1/08

(52) U.S. Cl. 359/9

(57) ABSTRACT

A method of computing a computer generated hologram (CGH) using a look-up table and spatial redundancy and an apparatus thereof are disclosed. The method in accordance with an embodiment of the present invention can includes computing one principal fringe pattern for each point of a target object that is separated by a same distance from a reference point of a hologram plane, storing the principal fringe pattern in accordance with a distance between each point of the target object and the reference point, computing identity data representing whether each point of an input image and adjacent points are identical to one another, computing an n-point fringe pattern by combining n principal fringe patterns and computing hologram information by matching the n-point fringe pattern to n successive points identified from the identity data. Here, the n is a natural number.

### BACKGROUND

1. Technical Field

The present invention is related to a method of generating hologram, more specifically to a method of generating 3D video computer generated hologram using a look-up table and spatial redundancy, and an apparatus thereof.

2. Description of the Related Art

Studies are underway to develop 3-dimensional images and image playing back technologies, and it is expected that a next generation display as a real-like image media that can increase the level of visual information higher is about to be developed. Moreover, 3-dimensional images are real-like and more natural than 2-dimensional images, and thus there has been an increasing demand for 3-dimensional images.

Among these 3-dimensional image technologies, holography is a technique that allows an observer to view a virtual 3-dimensional image when a recorded image (hologram) is viewed by a particular distance from the front surface of the recorded image.

The holographic method allows a hologram manufactured by a laser to appear three dimensional viewed by human eyes without any special observation devices. Accordingly, the holographic method is excellent in 3-dimensionality and has been regarded as one of the most attractive approaches for creating the most authentic illusion of observing volumetric objects without human fatigue.

So far, some approaches for generation of digital hologram patterns have been suggested. One of them is the ray-tracing method, which is commonly used to calculate diffraction of light when calculating a hologram pattern. In this method, a target object is regarded as a set of points, and hologram patterns for all points of the target object is calculated and added together. However, this method suffers from the computational complexity because it requires one-by-one calculation of the fringe pattern per image point per hologram sample, making it difficult for real-time playing back.

To overcome this problem, a look-up table (LUT) method that allows a real-time processing was proposed. In this method, all fringe patterns corresponding to point source contributions from each of the possible locations in an image volume are precomputed and stored in the LUT. However, this method also involves a great number of fringes as the object becomes bigger, and thus the look-up table becomes too big.

To overcome this problem, a novel look-up table (N-LUT, which is a new type of loop-up table) method that can dramatically reduce the memory capacity of a look-up table while maintaining the high-speed computing speed, like the conventional look-up table method has been suggested. Nevertheless, this method also involves a great number of points to be computed as the resolution of an image to be computed becomes higher, increasing the computation time and making it difficult for practical application.

### SUMMARY

The present invention provides a method for computing a computer generated hologram using a look-up table and spatial redundancy that allows real-time playing back for 3-dimensional hologram images, and an apparatus thereof.

Other problems that the present invention solves will become more apparent through the following embodiments described below.

An aspect of the present invention provides a method of computing a hologram. The method in accordance with an embodiment of the present invention can includes computing one principal fringe pattern for each point of a target object that is separated by a same distance from a reference point of a hologram plane, storing the principal fringe pattern in accordance with a distance between each point of the target object and the reference point, computing identity data representing whether each point of an input image and adjacent points are identical to one another, computing an n-point fringe pattern by combining n principal fringe patterns and computing hologram information by matching the n-point fringe pattern to n successive points identified from the identity data. Here, the n is a natural number.

Another aspect of the present invention provides a hologram computing apparatus. The apparatus in accordance with an embodiment of the present invention can include a fringe calculator, which computes one principal fringe pattern with respect to each point of a target object that is separated by a same distance from a reference point of a hologram plane, a look-up table, which stores the principal fringe pattern in accordance with a distance between each point of the target object and the reference point, an identity parser, which computes identity data representing whether each point of an input image and adjacent points are identical to one another, a point fringe calculator, which computes an n-point fringe pattern by combining n principal fringe patterns, and a hologram calculator, which computes hologram information by matching the n-point fringe pattern to n successive points identified from the identity data. Here, the n is a natural number.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 shows a method of obtaining 3-dimensional information using holography in accordance with an embodiment of the present invention.

FIG. 2 shows a hologram computing apparatus in accordance with an embodiment of the present invention.

FIG. 3 shows a brightness image and a depth image in accordance with an embodiment of the present invention.

FIG. 4 is a diagram illustrating a fringe pattern with respect to three points in accordance with an embodiment of the present invention.

FIG. 5 is a diagram illustrating a principal fringe pattern and an n-point fringe pattern in accordance with an embodiment of the present invention.

FIG. 6 is a diagram illustrating how a hologram pattern is computed by using spatial redundancy data and a fringe pattern with respect to a computed n point in accordance with an embodiment of the present invention.

FIG. 7 is a flow diagram illustrating a process of computing a hologram in accordance with an embodiment of the present invention.

FIG. 8 is a flow diagram illustrating a process of computing hologram information by matching a principal fringe pattern and an n-point fringe pattern in accordance with an embodiment of the present invention.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

Certain embodiments of the present invention will be described below in detail with reference to the accompanying drawings. Those components that are the same or are in correspondence are rendered the same reference numeral regardless of the figure number, and redundant descriptions are omitted. Before describing certain embodiments of the present invention, a general principle and a system for obtaining 3-dimensional information using holography will be first described below.

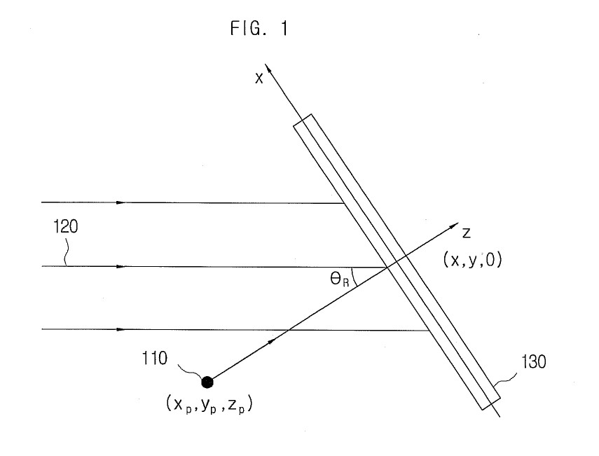

FIG. 1 shows a method of obtaining 3-dimensional information using holography in accordance with an embodiment of the present invention.

In holography, a simple hologram can be made by superimposing two beams from the same laser beam from a laser. One hits a screen normally, and the other one hits a target object. Here, the beam hitting the screen normally is referred to as a reference beam (the reference beam 120), and the beam hitting the target object is referred to as an object beam.

Since the object beam is a beam that reflects from the surface of the target object, the relative phase between the two beams varies, depending on the distance between the surface of the object and the screen. Here, the reference beam, which is not deformed, and the object beam interfere with each other to form an interference pattern, and then the interference pattern is stored in the screen. The recorded film, in which the interference pattern is stored, is referred to as a hologram.

A computer generated hologram (hereinafter, referred to as CGH) pattern is digitally computed by the coordinate (x, y, z) and the intensity value I of pixels. The CGH is used in obtaining a 3-dimensional hologram image. The geometry for computing the Fresnel hologram of an object image is shown in FIG. 1. Although the following description focuses on the CGH, it shall be apparent that the present invention is not restricted to this example.

The hologram is located at an x-y plane 130. Here, the location coordinate of a pth point of the object is specified by (xₚ, yₚ, zₚ) 110, and each object point is assumed to have an associated real-valued magnitude and phase of aₚ and Φₚ, respectively. These are used for the following equation by a computer.

In the hologram, a complex amplitude O(x, y) can be obtained by the superposition of the object beam, as expressed by the following equation 1.

$$O ( x , y ) = {\sum }_{p = 1}^{N} \frac{{a}_{p}}{{r}_{p}} exp [ j ( {kr}_{p} + {φ}_{p} ) ] \qquad ( 1 )$$

Here, p is points (object points) constituting an object, and N is the number of object points. aₚ is the magnitude of the object beam, and k is a frequency vector and defined as k=2 π/λ, in which λ is the free space wavelength of the light. rₚ is a sloping distance between the pth point of the object and the point on the hologram plane of (x, y, 0) and is defined by the following equation 2.

rₚ=\sqrt{(x−xₚ)²+(y−yₚ)²+zₚ²} (2)

A complex amplitude R(x, y) of the reference beam, which is a plane beam, is expressed by the following equation 3.

R(x, y)=a_{R} exp[j(kx sin θ_{R})] (3)

Here, a_{R} and θ_{R} are the magnitude of the reference beam and the incident angle of the reference beam, respectively. The overall grid intensity I(x, y) of the hologram plane is an interference pattern between the object beam O(x, y) and the reference beam R(x, y) and is expressed by the following equation 4.

$$I ( x , y ) = {\vert R ( x , y ) + O ( x , y ) \vert}^{2} = {\vert R ( x , y ) \vert}^{2} + {\vert O ( x , y ) \vert}^{2} + 2 \vert R ( x , y ) \vert \vert O ( x , y ) \vert cos [ {kr}_{p} + kx sin {θ}_{R} + {φ}_{p} ] \qquad ( 4 )$$

In the equation 4, a first part |R(x,y)|² is the intensity of the reference beam, and a second part |O(x, y)|² is the intensity of the object beam. A third part 2|R(x, y)∥O(x, y)|cos [krₚ+kx sin θ_{R}+φₚ] is the interference pattern between the object beam and the reference beam that partially includes hologram information, and includes phase information in accordance with the spatial location of the object beam.

In the following equation 5, the hologram information is included in the third part only, and thus the hologram information I(x, y) can be expressed as follows.

$$I ( x , y ) = 2 {\sum }_{p = 1}^{N} \frac{{a}_{p}}{{r}_{p}} cos ( {kr}_{p} + kx sin {θ}_{R} + {φ}_{p} ) \qquad ( 5 )$$

Specifically, in the conventional beam tracing method, a hologram pattern can be computed by the equation 5. Nevertheless, as it can be seen in the equation 5, the equation for computing the hologram pattern is very complicated so that it is quite difficult to compute hologram patterns in real time.

Proposed to solve the above problem is a look-up table method in which fringe patterns that can express the entire points inside a particular object are precomputed and stored in the look-up table, and a hologram is computed by bring each fringe pattern in accordance with a 3-dimensional image to be computed.

Before describing the components of the present invention, a preconditioned aspect of certain embodiments of the present invention is as follows. Generally, an image space is not separable. However, since the human being's optical system is limited in its ability, the resolution can be selected without compromising the image quality. Here, the degree of separation is small enough not to be recognized by the eyes of a person so that two successively formed points can be recognized as if the two points were not separated from each other. For example, a human recognizes two points having a gap of 3 milliradians as one single point. Accordingly, when an image is viewed from a distance of 500 nun, two points having a gap of 150 microns or less (500 mm×0.003=150 microns) can be recognized as one single point. In an embodiment of the present invention, the degree of horizontal and vertical separation will be set to 150 microns.

In the look-up table method, fringe patterns have to be precomputed. The fringe pattern T(x, y; xₚ, yₚ, zₚ) is reference brightness that can express each point and can be expressed by the following equation 6 using the equation 5.

$$T ( x , y ; {x}_{p} , {y}_{p} , {z}_{p} ) ≡ \frac{1}{{r}_{p}} cos [ {kr}_{p} + kx sin {θ}_{R} + {φ}_{p} ] \qquad ( 6 )$$

Here, rₚ , which is expressed by the equation 2, is the distance between the pth object point of (xₚ, yₚ, zₚ) and the point on the hologram plane of (x, y, 0).

In this method, a hologram is not computed by computing the fringe pattern of each point whenever it is required, like the equation 5, but the hologram is computed by using the pre-made look-up table, which is a set of fringe patterns for corresponding points (xₚ, yₚ, zₚ). Accordingly, in the look-up table method, the hologram information I(x, y) is finally provided as the following equitation 7. Here, N is the number of object points.

$$I ( x , y ) = {\sum }_{p = 1}^{N} {a}_{p} T ( x , y ; {x}_{p} , {y}_{p} , {z}_{p} ) \qquad ( 7 )$$

The look-up table (LUT) method has brought a tremendous increase in speed by using the precomputed fringe patterns for all possible points of an object image when holograms are combined. However, the biggest drawback of this method is that the number of precomputed fringe patterns is too many so that the memory capacity of the LUT, which stores the precomputed fringe patterns, will increase dramatically. For example, if it is assumed that, in the LUT method, an object space is 100 (width)×100 (height)×100 (depth), and the memory capacity of each fringe pattern is 1 MB, the memory capacity of the entire look-up table may require 1 MB×100×100×100=1 TB.

Proposed to solve this problem is N-LUT, which is a new type of loop-up table, that can significantly reduce the memory capacity of the look-up table while maintaining the high-speed computing speed, like the conventional look-up table method. Also, a high-speed digital holographic calculation method using the N-LUT is proposed. Specifically, in the N-LUT method, a 3D object image is approximated as a set of discretely sliced image planes with different depth, and only the fringe pattern of the center object point on each image plane is precomputed, so-called a principal fringe pattern (PFP), and stored in the N-LUT so that the size of the N-LUT can be significantly reduced. If a depth direction of the 3D object image is determined, the fringe patterns of the object points exist on a particular surface can be computed and added together to compute a hologram pattern on the particular planar surface by moving the precomputed and stored fringe pattern of that particular depth plane toward each object point of the particular depth plane. In the same way, hologram patterns for the entire object image can be computed by computing and adding all the holograms of the sliced image planes together. Accordingly, while the conventional LUT method requires fringe patterns for all directions, i.e., the width, the height, and the depth, of the object points to be stored, the proposed N-LUT method requires the principal fringe pattern (PFP) to be prestored only, thus dramatically reducing the required memory capacity of the N-LUT.

In the N-LUT method, fringe patterns are needed to be precomputed. That is, each fringe pattern T(x, y; zₚ) becomes a Fresnel zone plate having reference intensity for each depth plane, and can be expressed by the following equation 8.

$$T ( x , y ; {z}_{p} ) ≡ \frac{1}{{r}_{p}} cos [ {kr}_{p} + kx sin {θ}_{R} + {φ}_{p} ] \qquad ( 8 )$$

Here, rₚ , which is expressed by the equation 2, is the distance between the pth object point of (xₚ, yₚ, zₚ) and the point on the hologram plane of (x, y, 0). In the newly proposed N-LUT method, only the fringe pattern of the center object point on each image plane is precomputed and stored in the N-LUT. If a depth direction of the 3D object image is determined, the fringe patterns of the object points exist on a particular surface can be computed and added together to compute a hologram pattern on the particular planar surface by moving the precomputed and stored fringe pattern of that particular depth plane toward each object point of the particular depth plane. In the same way, hologram patterns for the entire object image can be computed by computing and adding all the holograms of the sliced image planes together. Accordingly, in the N-LUT method, the hologram information I(x, y) can be expressed by the following equation 9.

$$I ( x , y ) = {\sum }_{p = 1}^{N} {a}_{p} T ( x - {x}_{p} , y - {y}_{p} ; {z}_{p} ) \qquad ( 9 )$$

By using the N-LUT method, a hologram pattern can be computed and restored at high-speed. Nevertheless, the method has a great number of object points to be computed if an image to be computed has an increase in resolution, thus increasing the computational complexity.

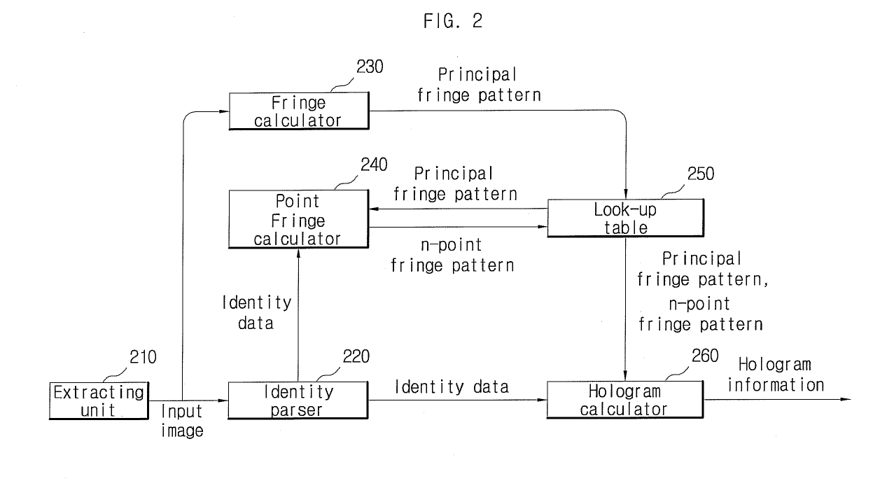

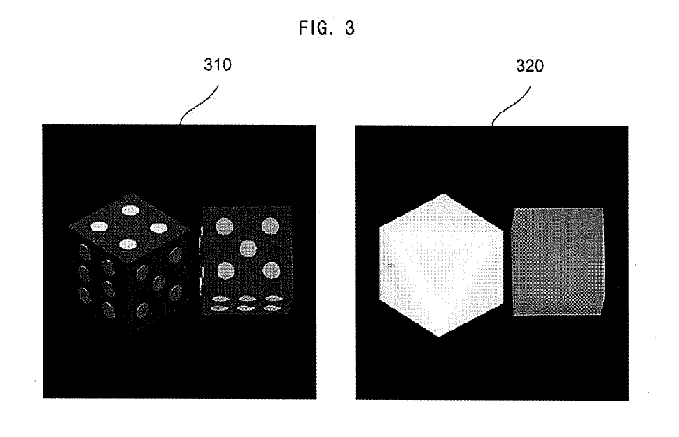

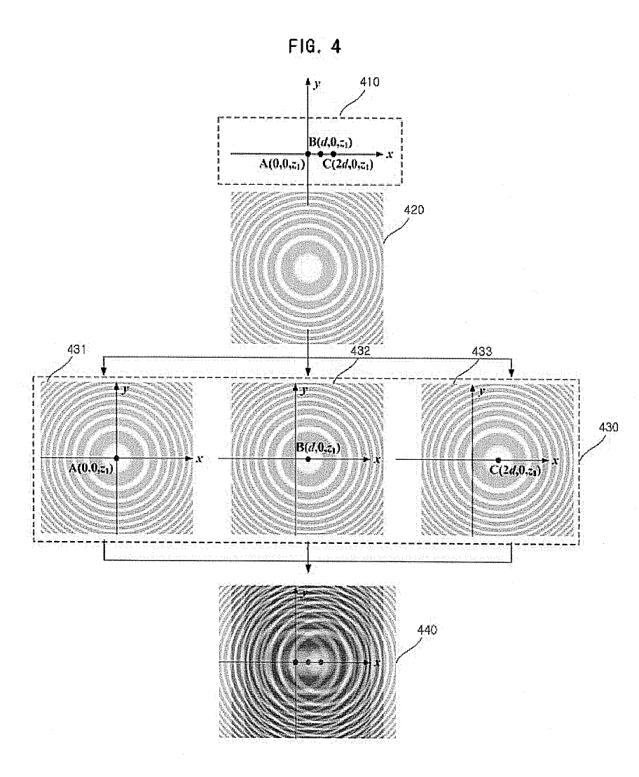

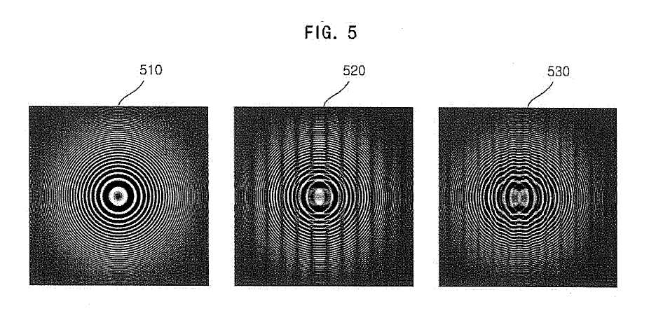

FIG. 2 shows a hologram computing apparatus in accordance with an embodiment of the present invention, and FIG. 3 shows a brightness image and a depth image in accordance with an embodiment of the present invention. FIG. 4 is a diagram illustrating a fringe pattern with respect to three points in accordance with an embodiment of the present invention, and FIG. 5 is a diagram illustrating a principal fringe pattern and an n-point fringe pattern in accordance with an embodiment of the present invention.

Referring to FIG. 2, a hologram computing apparatus is constituted by an extracting unit 210, an identity parser 220, a fringe calculator 230, a point fringe calculator 240, a look-up table 250 and a hologram calculator 260.

The extracting unit 210 extracts a brightness image 310 and a depth image 320. The brightness image 310 represents the brightness of a typical 2-dimensional image, and the depth image 320 represents the depth information of the brightness image 310. FIG. 3 shows the brightness image 310 and the depth image 320 when they are outputted. The extracting unit 210 combines the brightness image 310 and the depth image 320 into a predetermined form and outputs an input image to the identity parser 220.

The identity parser 220 extracts identity data from a 3-dimensional image in accordance with the spatial redundancy. The brightness of adjacent pixels in a typical image has a similar value. That is, the typical image has spatial redundancy. The brightness and depth of adjacent pixels in a 3-dimensional image also has a similar value. Additionally, some points in some areas have a identical brightness and depth value. The identity parser 220 computes identity data that is extracted by tying points having a same brightness and depth value. For example, when the brightness and depth values of point A (0, 0, 0) and point B (1, 0, 0) in a 3-dimentitional coordinate are compared, the identity parser 220 generates identity data that represents the identity of the points A and B if the points A and B have a same brightness and depth value. Also, the identity parser 220 can perform an identity analysis not only for two successive points but also for three or more successive points. Hereinafter, if n-adjacent points have an identical brightness and depth value, the n-adjacent points will be referred to as n-successive points.

The fringe calculator 230 computes principal fringe patterns for the target object. As illustrated and described in the equation 9, the fringe calculator 230 computes principal fringe patterns that are needed when using the N-LUT method and outputs the principal fringe patterns as a look-up table.

The point fringe calculator 240 computes an n-point fringe pattern by receiving the identity data and the principal fringe pattern. The n-point fringe pattern is a fringe pattern that can express a hologram pattern of n-successive points. Hereinafter, the n-point fringe pattern will be described in more detail with reference to FIG. 4.

The n-point fringe pattern, which can compute a hologram pattern corresponding to a plurality of points, can be obtained by the way shown in FIG. 4. If it is assumed that there is a principal fringe pattern 420 for one point and a distance between the one point and its adjacent point is d, a 3-point fringe pattern 440 for three adjacent points 410 can be made by shifting the principal fringe pattern 420 for the one point in accordance with the position of each point. Specifically, a fringe pattern 431, which is located on an original location, a fringe pattern 432, which is shifted by d in order to express a point that is separated by d from the one point, and a fringe pattern 433, which is shifted by 2d in order to express a point that is separated by 2d from the one point, are computed. The 3-point fringe pattern 440, which can express the three adjacent points 410, is computed by adding the three fringe patterns 431, 432 and 433 together.

Accordingly, the n-point fringe pattern Tₙ(x, y; zₚ), which can express n-successive points, can be expressed by the following equation 10.

$${T}_{n} ( x , y ; {z}_{p} ) ≡ {\sum }_{k = 1}^{n} T ( x - ( k - 1 ) d , y ; {z}_{p} ) \qquad ( 10 )$$

Although the above embodiment has been described with a fringe pattern for three successive points, it shall be apparent that a fringe pattern for a different number of successive points can be obtained by the method as described above. Illustrated in FIG. 5 are a 2-point fringe pattern 520 and a 3-point fringe pattern 530 that are formed by using a principal fringe pattern 510 through the above method.

Referring to FIG. 2 again, the point fringe calculator 240 computes an n-point fringe pattern and outputs the n-point fringe pattern as a look-up table 250.

The look-up table 250 is a space to store a principal fringe pattern and an n-point fringe pattern for the points of a target object that are separated by a same distance from a reference point of the hologram plane. The principal fringe pattern of the look-up table 250 can be computed by the equation 8 described above. Then, the look-up table 250 outputs the principal fringe pattern and the n-point fringe pattern to the hologram calculator 260.

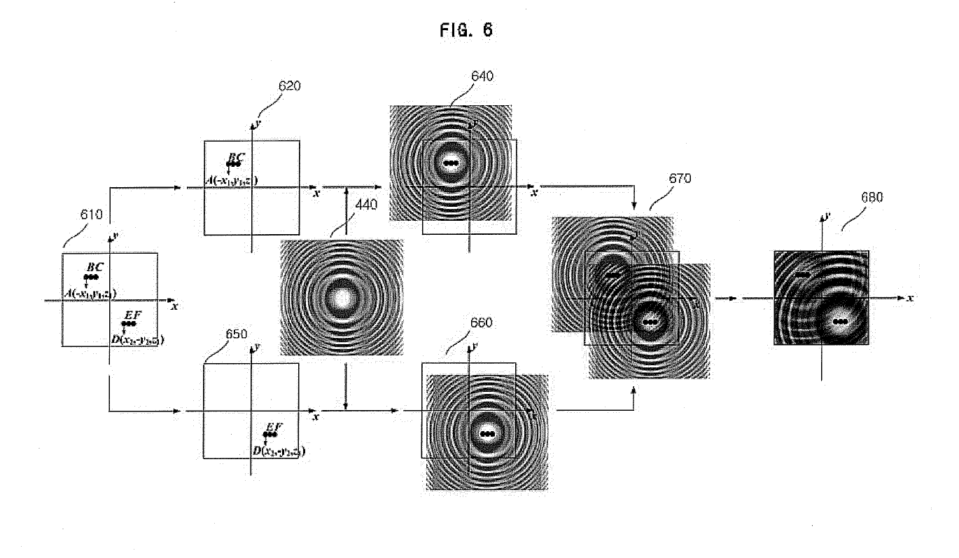

The hologram calculator 260 computes a hologram by receiving the principal fringe pattern, the identity data and the n-point fringe pattern. FIG. 6 is a diagram illustrating how a hologram pattern is computed by using spatial redundancy data and a fringe pattern for computed n-successive points in accordance with an embodiment of the present invention. Referring to FIG. 6, there are six point light sources A, B, C, D, E and F in an input image 610 in accordance with an embodiment of the present invention. Among them, an image 620 of a z₁ depth plane is constituted by a point (−x₁, y₁, z₁) and two adjacent points, and an image 650 of a z₂ depth plane is constituted by a point (x₂, −y₂, z₂) and two adjacent points. For a combined image 640 of the z₁ depth plane, the hologram computing apparatus 260 shifts the fringe pattern 440 for three points on the depth plane of z₁ to the x and y directions with amounts of −x₁ and y₁, respectively, since the position of the reference point light source A is (−x₁,y₁,z₁). For a combined image 660 of the z₂ depth plane, the hologram computing apparatus 260 shifts the fringe pattern 440 for three points on the depth plane of z₂ to the x and y directions with amounts of x₁ and −y₁, respectively, since the position of the reference point light source D is (x₁,−y₁,z₁). Then, the hologram computing apparatus 260 combines the n-point fringe patterns to compute the CGH. Also, the hologram computing apparatus 260 computes hologram information 680 by using the CGH, as shown in the equation 9.

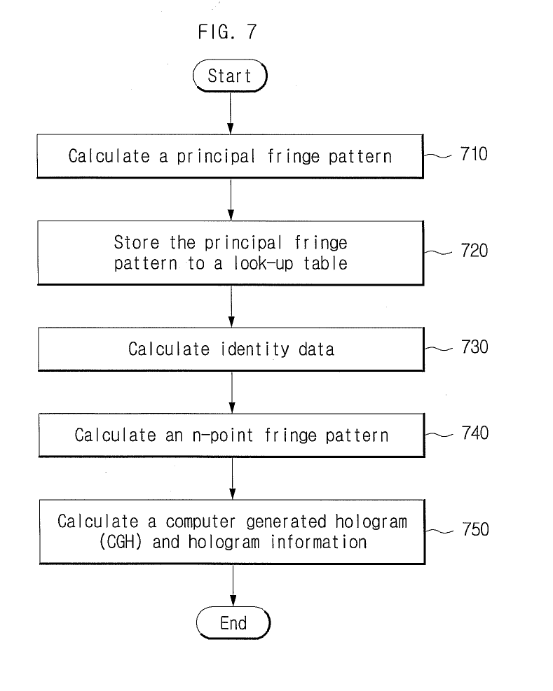

Referring to FIG. 7, a method of computing a hologram using a look-up table and spatial redundancy will be described below. For the convenience of description and understanding, the mode units constituting the hologram computing apparatus will be collectively referred to as a “hologram computing apparatus.” Below, no redundant description of the hologram computing apparatus will be repeated when describing a process of computing a hologram.

FIG. 7 is a flow diagram illustrating a process of computing a hologram in accordance with an embodiment of the present invention.

In step 710, the hologram computing apparatus computes a principal fringe pattern by referring to an input image. The principal fringe pattern, which is a fringe pattern stored in the look-up table 250 in the N-LUT method, is a fringe pattern with respect to a depth direction of the object.

In step 720, the hologram computing apparatus stores the principal fringe pattern to the look-up table.

In step 730, the hologram computing apparatus computes identity data of the input image. That is, the hologram computing apparatus computes identity data that is extracted by tying adjacent points having a same brightness and depth value.

In step 740, the hologram computing apparatus computes an n-point fringe pattern by using the identity data and the principal fringe pattern.

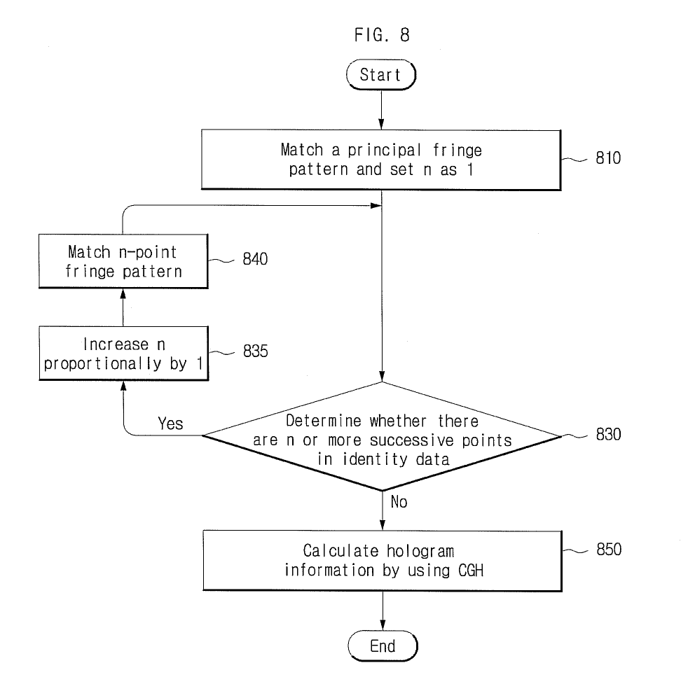

In step 750, the hologram computing apparatus computes a computer generated hologram (CGH) by matching the principal fringe pattern, the identity data and the n-point fringe pattern to each object point of the target object, and computes hologram information through the CGH. The step 750 will be described in more detail below with reference to FIG. 8.

FIG. 8 is a flow diagram illustrating a process of computing hologram information by matching a principal fringe pattern and an n-point fringe pattern in accordance with an embodiment of the present invention.

In step 810, the hologram computing apparatus selects a point (a point that is not identical to the adjacent points) that is not included in the identity data and matches the principal fringe pattern to the selected point, and n is set as 1. Here, n is a natural number.

In step 830, the hologram computing apparatus determines whether there are n or more successive points in the identity data.

In step 835, if there are n or more successive points, the hologram computing apparatus increases n proportionally by 1.

In step 840, the hologram computing apparatus matches the n-point fringe pattern to the n successive points. Then, the hologram computing apparatus performs the processes from the step 830.

In step 850, if there are not n or more successive points, the hologram computing apparatus computes hologram information by using the CGH. The method of computing a hologram using the CGH has been described above with reference to the equation 9.

Although the process for computing hologram information has matched a fringe pattern by appointing the order based on the number of successive identical points, it is also possible that the fringe pattern can be matched in accordance with the order of coordinates of the target object. Here, the n-point fringe pattern can be stored in the look-up table.

The hologram computing apparatus and the method for computing a hologram can reduce the computational complexity for computing holograms. Below, the effects of the hologram computing apparatus in accordance with an embodiment of the present invention will be described with reference to the following table. The number of points needed to be computed by the above method for computing a hologram is shown in the following table.

| | Number of spatially redundant | | | |
|---|---|---|---|---|
| | data of the test 3-D object | | | |
| | Conventional | Proposed | Proposed | Proposed |
| Computed | method | method | method | method |
| object points | (1-point) | (2-point) | (3-point) | (4-point) |
| 1-point | 78,726 | 51,828 | 50,004 | 49,491 |
| 2-point | — | 13,449 | 8,697 | 8,508 |
| 3-point | — | — | 3,776 | 2,337 |
| 4-point | — | — | — | 1,302 |
| Total | 78,726 | 65,277 | 62,477 | 61,638 |
| Reduction ratio | 100 | 82.9 | 79.4 | 78.3 |
| (%) | | | | |

The 1-point fringe pattern represents the conventional N-LUT method. In this case, a total of 78,726 points has been computed in order to compute a hologram. Compared to the amount of computation needed for the 1-point fringe pattern, the 2-point fringe pattern, the 3-point fringe pattern and the 4-point fringe pattern have 82.9%, 79.4% and 78.3%, respectively.

The computation time for computing a hologram in accordance with the above method is shown in the following table.

| | N-LUT | Proposed method | | |
|---|---|---|---|---|
| | method | 2-point | 3-point | 4-point |
| Average computation time | 11.76 | 9.53 | 9.16 | 9.05 |
| for one object point (ms) | (100%) | (81.0%) | (77.9%) | (77.0%) |

In the conventional N-LUT method, it takes an average of 11.76 ms to compute one point. In the case of using the 2-point fringe pattern, it takes an average of 9.53 ms to compute one point that is 81% compared to 100% of the conventional N-LUT method. Likewise, in the cases of the 3-point fringe pattern, it takes an average of 9.16 ms to compute one point that is 77.9% compared to 100% of the conventional N-LUT method, and in the cases of the 4-point fringe pattern, it takes an average of 9.05 ms to compute one point that is 77.0% compared to 100% of the conventional N-LUT method. Accordingly, the method of computing a hologram in accordance with an embodiment of the present invention can reduce the computation complexity, compared to the conventional N-LUT method.

The method for computing and reconstructing a computer-generated hologram using a look-up table and spatial redundancy in accordance with an embodiment of the present invention can be performed by a device, for example, a mobile communication terminal, after the method is stored in a storage medium. Here, the storage medium can be a magnetic or optically readable storage medium, for example, a hard disk, a video tape, CD, VCD and DVD, or a database of a client or sever computer that is built on off-line or on-line.

While the spirit of the invention has been described in detail with reference to a certain embodiment, the embodiment is for illustrative purposes only and shall not limit the invention. It is to be appreciated that those skilled in the art can change or modify the embodiment without departing from the scope and spirit of the invention. Particularly, an analysis of spatial redundancy can be performed by various other methods, for example, horizontally, vertically, diagonally or in blocks. Also, the n-point fringe pattern can be pre-made to compute a hologram, or the 1-point fringe pattern is pre-made and the n-point fringe pattern can be made whenever it is required to compute a hologram.

What is claimed is:

1. A method of computing a hologram, the method comprising:
computing one principal fringe pattern for each point of a target object that is separated by a same distance from a reference point of a hologram plane;
storing the principal fringe pattern in accordance with a distance between each point of the target object and the reference point;
computing identity data representing whether each point of an input image and adjacent points are identical to one another;
computing an n-point fringe pattern by combining n principal fringe patterns; and
computing hologram information by matching the n-point fringe pattern to n successive points identified from the identity data,
wherein the n is a natural number.

2. The method of claim 1, wherein the principal fringe pattern is computed by using the following equation,
$$T ( x , y ; {z}_{p} ) ≡ \frac{1}{{r}_{p}} cos [ {kr}_{p} + kx sin {θ}_{R} + {φ}_{p} ]$$
whereas, p is a natural number, T is the principal fringe pattern, rₚ is a distance between a pth point and a point (x, y, 0), k is defined as k=2 π/λ, in which λ is the free space wavelength of the light, θ_{R} is an angle between a reference beam and an object beam, and Φₚ is a phase value of an object beam of a pth point of the target object.

3. The method of claim 2, wherein the n-point fringe pattern is computed by using the following equation,
$${T}_{n} ( x , y ; {z}_{p} ) ≡ {\sum }_{k = 1}^{n} T ( x - ( k - 1 ) d , y ; {z}_{p} )$$
whereas, Tₙ is the n-point fringe pattern.

4. The method of claim 3, wherein the hologram information is computed by using the following equation,
$$I ( x , y ) = {\sum }_{p = 1}^{N} {a}_{p} T ( x - {x}_{p} , y - {y}_{p} ; {z}_{p} )$$
whereas, I is the hologram information, aₚ is an intensity value of the object beam of the pth point of the target object, and N is the number of points of the target object.

5. A hologram computing apparatus comprising:
a fringe calculator configured to compute one principal fringe pattern with respect to each point of a target object that is separated by a same distance from a reference point of a hologram plane;
a look-up table configured to store the principal fringe pattern in accordance with a distance between each point of the target object and the reference point;
an identity parser configured to compute identity data representing whether each point of an input image and adjacent points are identical to one another;
a point fringe calculator configured to compute an n-point fringe pattern by combining n principal fringe patterns; and
a hologram calculator configured to compute hologram information by matching the n-point fringe pattern to n successive points identified from the identity data,
wherein the n is a natural number.

6. The apparatus of claim 5, wherein the principal fringe pattern is computed by using the following equation,
$$T ( x , y ; {z}_{p} ) ≡ \frac{1}{{r}_{p}} cos [ {kr}_{p} + kx sin {θ}_{R} + {φ}_{p} ]$$
whereas, p is a natural number, T is the principal fringe pattern, rₚ is a distance between a pth point and a point (x, y, 0), k is defined as k=2 π/λ, in which λ is the free space wavelength of the light, θ_{R} is an angle between a reference beam and an object beam, and Φₚ is a phase value of an object beam of a pth point of the target object.

7. The apparatus of claim 6, wherein the n-point fringe pattern is computed by using the following equation,
$${T}_{n} ( x , y ; {z}_{p} ) ≡ {\sum }_{k = 1}^{n} T ( x - ( k - 1 ) d , y ; {z}_{p} )$$
whereas, Tₙ is the n-point fringe pattern.

8. The apparatus of claim 7, wherein the hologram information is computed by using the following equation,
$$I ( x , y ) = {\sum }_{p = 1}^{N} {a}_{p} T ( x - {x}_{p} , y - {y}_{p} ; {z}_{p} )$$
whereas, I is the hologram information, aₚ is an intensity value of the object beam of the pth point of the target object, and N is the number of points of the target object.
